(19) United States
(12) Patent Application Publication
(10) Pub. No.: US 2013/0073725 A1
(43) Pub. Date: Mar. 21, 2013

(54) SYSTEM AND METHOD FOR AUTOMATED CONTENT DISTRIBUTION

(71) Applicant: UNWIRED PLANET, INC., Redwood City, CA (US)

(72) Inventors: Marc-Andre Bordeleau, Shawinigan (CA); Michel Levesque, Drummondville (CA); Audry Larocque, Montreal (CA)

(73) Assignee: UNWIRED PLANET, INC., Redwood City, CA (US)

(21) Appl. No.: 13/671,407

(22) Filed: Nov. 7, 2012

Related U.S. Application Data
(63) Continuation of application No. 11/154,273, filed on Jun. 16, 2005.
(60) Provisional application No. 60/579,646, filed on Jun. 16, 2004.

(51) Int. Cl. G06F 15/173

(52) U.S. Cl. 709/224

(57) ABSTRACT

A system and method for automated content distribution is disclosed. A content distribution system includes a detector module for intercepting a network communication and verifying whether content is available for a client, and a notification module coupled to the detector module for notifying the client that the content is available. A method for content distribution includes intercepting a network communication, analyzing the network communication for determining whether content is available for a client, and notifying the client that the content is available.

### CROSS-REFERENCE TO RELATED APPLICATIONS

This application claims priority to U.S. Provisional Patent Application No. 60/579,646, filed Jun. 16, 2004, the disclosure of which is hereby incorporated herein by reference.

### TECHNICAL FIELD

The present invention relates generally to data communications and, more specifically, to a system and method for automated content distribution.

### BACKGROUND OF THE INVENTION

With the exponential increase of today's network usage, both in terms of total traffic and number of users, Internet Service Providers (ISPs) have to adapt very quickly in order to sustain the demand for new services. Users have access to a wide variety of client applications that utilize the Internet to gather information, such as web browsers, email clients, and peer-to-peer (P2P) file sharing software, among many others. Furthermore, these applications are constantly evolving, as well as the communication protocols they use. For instance, software applications may periodically have new versions or plug-in modules available for download.

In cellular and wireless systems, service operators or carriers may have access to special protocols for delivering marketing information about their products. For example, operators sometimes use Short Messaging Service (SMS) messages to notify cellular users of the existence of a new device or software application. A prior art method for distributing software involves using a mass SMS messaging campaign originated by the carrier. Another prior art method involves embedding a mechanism in client's application for automatically notifying the client about a software update and for delivering it to the client's device. Such mechanisms are based on querying information from a central server. Specifically, a small subset of functions within the client software performs a simple lookup on the central server using standard or private protocols to verify the existence of a new update. If a client update is available, the user is so notified and asked to install the update.

### BRIEF SUMMARY OF THE INVENTION

The present invention relates to a system and method for automated content distribution. The invention may, for example, perform a network traffic analysis for detecting software and protocol versions, maintain a list of software and protocol versions for which an update exists, notify the user of any available updates, and provide the new software or protocol, among other functions. The invention may also perform a marketing campaign individually targeted to network users.

In one exemplary embodiment, an automated content distribution system includes a detector module for intercepting a network communication and verifying whether content is available for a client, and a notification module coupled to the detector module for notifying the client that the content is available. In another exemplary embodiment, a method for automated content distribution includes intercepting a network communication, analyzing the network communication for determining whether content is available for a client, and notifying the client that the content is available.

It is an object of the present invention to provide automated software distribution over the network. It is another object of the present invention to provide real-time software distribution. It is a further object of the present invention to provide software distribution offline from the network. In addition, it is an object of the present invention to provide automated content distribution targeted to individual or groups of subscribers.

### BRIEF DESCRIPTION OF THE DRAWINGS

FIG. 1 is a block diagram of an automated content distribution system according to one embodiment of the present invention;

FIG. 2 is a block diagram of an automated content distribution system according to one embodiment of the present invention in a wireless cellular network;

FIG. 3 is a block diagram of a detection method according to one embodiment of the present invention;

FIG. 4 is a block diagram of a notification method according to one embodiment of the present invention;

FIG. 5 is a block diagram of a bandwidth optimization system according to one embodiment of the present invention;

FIG. 6 is a block diagram of a bandwidth optimization system according to one embodiment of the present invention;

FIG. 7 is a flowchart of a method performed by a provisioning discovery server according to one embodiment of the present invention;

FIG. 8 is a flowchart of a method performed by a UDP listener module according to one embodiment of the present invention;

FIG. 9 is a flowchart of a method performed by a UDP listener module according to one embodiment of the present invention;

FIG. 10 is a block diagram of a hashing table according to one embodiment of the present invention;

FIG. 11 is a flowchart of a method performed by a provisioning core module according to one embodiment of the present invention;

FIG. 12 is a flowchart of a method performed by a dispatcher probe module according to one embodiment of the present invention;

FIG. 13 is a flowchart of a method performed by IMEI/MSISDN lookup module according to one embodiment of the present invention;

FIG. 14 is a flowchart of a method performed by SMS sender module according to one embodiment of the present invention;

FIG. 15 is a block diagram of a client repository server according to one embodiment of the present invention; and

FIG. 16 is a block diagram of push proxy gateway/server according to one embodiment of the present invention.

### DETAILED DESCRIPTION

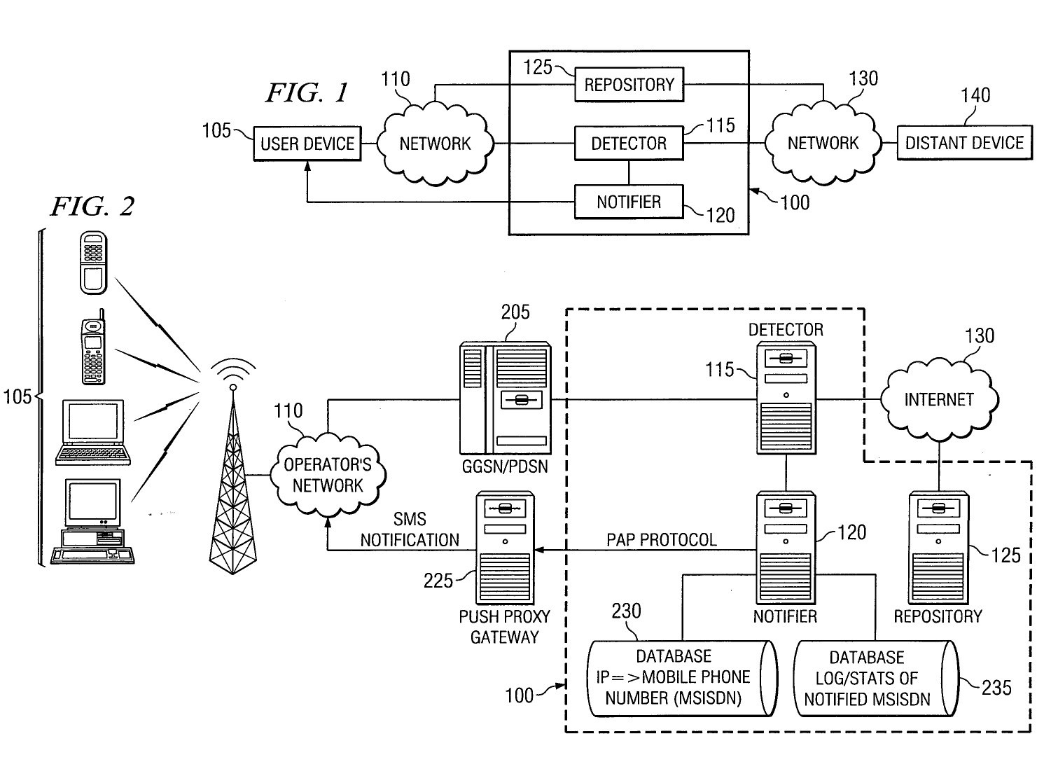

FIG. 1 is a block diagram of an automated content distribution system 100 according to an exemplary embodiment of the invention. User device 105 and distant device 140 may be standard computers, servers, laptops, personal digital assistants (PDAs), mobile phones, or any other entities that are operable to connect to networks 110 and 130. Networks 110 and 130 may be wired networks such as, for example, local area networks (LAN), or wireless networks such as, for example, IEEE 802.11b (WiFi), General Packet Radio Service (GPRS), Universal Mobile Telecommunications Service (UMTS), Personal Communications Service (PCS), Global System for Mobile communications (GSM), Digital-Advanced Mobile Phone Service (DAMPS), Interim Standard (IS)-136, IS-95, Code Division Multiple Access (CDMA) 2000, Wide-band CDMA (W-CDMA), or Universal Mobile Telecommunications Service (UMTS) standards, or any other Personal Communications Services (PCS), Time Division Multiple Access (TDMA) or CDMA wireless network. The term “network” as used herein refers generally to typical infrastructure and components of a telecommunications network, such as base stations, mobile switching centers, switching and control networks, and any other related gateways, nodes or elements, including Home Location Registers (HLRs), Visitor Location Registers (VLRs), Signaling Control Points, message centers, and the like. Networks 110 and 130 may also be, for example, the Internet. User device 105 may be equipped with an application that allows it to communicate with distant device 140. For instance, a laptop (user device 105) may use a Web browser (application) to download a web page from a web server (distant device 140).

Detector module 115 is coupled between networks 110 and 130. In operation, detector module 115 intercepts network traffic that traverses the communication link between networks 110 and 130. Detector module 115 may, for example, make a copy of the network traffic so that network communications are not disturbed. Further, detector module 115 is responsible for performing packet inspection, preferably in real-time. Detector module 115 may include a protocol parser program for identifying a network subscriber and determining whether content is available for client 105. If content is available for a particular client 105, notifier module 120 may send a message targeted to that client 105. In one embodiment, the message may include the uniform resource locator (URL) of the content located in repository module 125, thereby allowing client 105 to download the content.

FIG. 2 is a more detailed block diagram of automated software distribution system 100 according to an exemplary embodiment of the present invention. Device 105 communicates with operator's network 110 which may be, for example, a GPRS network. Gateway GPRS Support Node/Packet Data Serving Node (GGSN/PDSN) 205 connects GPRS network 110 to network 130, which may be, for example, the Internet, through detector 115 of software distribution system 100. Detector module 115 is responsible for assessing network traffic to detect the presence or absence of a software application already installed in device 105 and for deciding whether or not to send the user an installation notification.

If a newer version of a given application or protocol is available, detector module 115 may signal the notification module 120 that user device 105 is equipped with an older version of the software application. Using information obtained from inspection of the network communication such as, for example, an internet protocol (IP) address, notification module 120 may notify client 105 of the existence of a software or protocol update. The combination of detector module 115 and notification module 120 may function as a packet analyzer. The packet analyzer may determine, for example, whether the client is already using a particular application or protocol, whether the software provisioning server is operational, whether the client device is able to receive notification in a particular format, and whether the client has already been notified about the application or protocol. When pre-determined conditions are met for a given client, the packet analyzer may send the client a notification.

In one embodiment, for example, notification over a GSM wireless network may be performed in the form of an SMS message. This notification may also contain an address of where the latest software application version is stored. In another embodiment, the SMS message may contain an URL pointing to the new software application's installer in repository module 125. As a person of ordinary skill in the art will recognize in light of this disclosure, detector module 115 may determine whether a new application or an application update is available to client 105. A load balancer module (not shown) may be used as a fail-safe module for bypassing software distribution system 100 so as to avoid network service interruption in the event that the software distribution system 100 fails.

In operation, software distribution system 100 acts as a node on the network path. In one embodiment, detector module 115 receives an IP packet and determines whether device 105 is running a software application partially based upon which port is being reached by the packet. Before sending an SMS notification to the client, detector module 115 may obtain the client's 105 mobile subscriber ISDN (MSISDN or phone number). This information may be requested from database 230 using the IP address encoded in the intercepted message. If there is no mobile phone number associated with the IP address, then the software distribution process may be aborted. If notification module 125 is able to get the user's mobile phone number, an installation notification may be sent to the client. For example, notification module 120 may send a push access protocol (PAP) message to push proxy gateway 225, which in turn may send an SMS notification to user 105 through network 110.

In order to avoid disturbing client 105 with multiple SMS notifications, notification module 120 may first determine whether that user has already received a notification. In one embodiment, a lookup is made on database 235 that contains notification information for device 105. Database 235 may contain, for example, a list of devices by international mobile equipment identification (IMEI), each device associated with a notification record. If detector module 115 determines that an SMS should be sent, notification module 120 may update database 235 accordingly. The notification record may include, for example, times and dates of prior notifications, preference settings whereby the user may decline to receive certain types of notification, and the like. Rules for determining whether an SMS should be sent to user 105 may be configurable by the service operator, and may be such that each device receives no more than a maximum number of SMS messages within a period of time.

An advantage of the present invention is that the initial optimization software distribution may be performed without a mass SMS mailing campaign. For example, instead of sending an SMS message to every device at once, users may be notified via SMS only when they are detected as not having the client optimization software installed on the device. This notification may contain a hyperlink that allows the user to download and install the client optimization software. Alternatively, notification step may be skipped and the software may be directly delivered. The invention may also handle, for example, users that have two devices for only one subscriber identity module (SIM) card since every device may automatically be updated or upgraded on an ongoing basis. Furthermore, as a person of ordinary skill in the art will recognize in light of this disclosure, the software distribution system 100 described herein may be used for distributing content, software or messages of any kind, including, for example, advertisements and marketing materials.

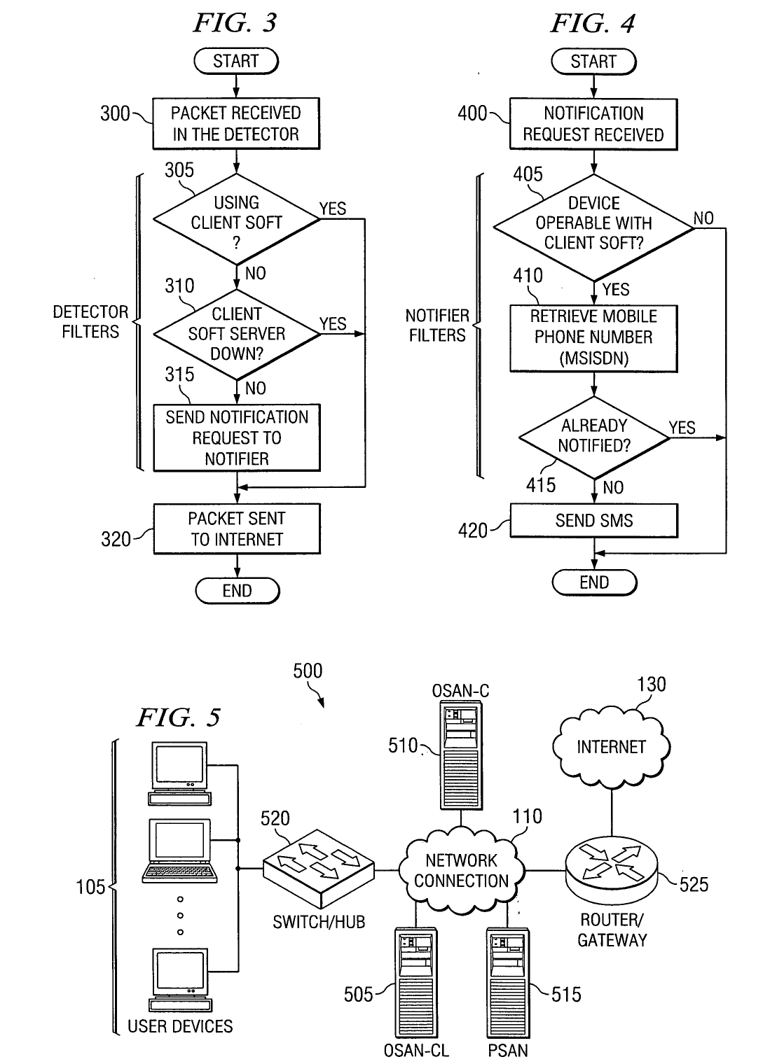

FIG. 3 is a block diagram of a detection method according to an exemplary embodiment of the present invention. In step 300, a packet is received in detector module 115, which analyzes its contents. Detector module 115 may also determine whether the client is using the software to be distributed in step 305 and whether the content server or repository 125 or other related server modules are available in step 310. If the client does not already have the content, software, or protocol, and the content server or repository 125 and other related server modules are in operation, a notification request is sent to notification module 120 in step 315. Independently of whether the notification is ultimately sent to the user, the packet is forwarded to the Internet 130 in step 320.

FIG. 4 is a block diagram of a notification method according to an exemplary embodiment of the present invention. In step 400, a notification request is received by notification module 120. Notification module 120 retrieves the mobile phone number from database 230 in step 410. In step 415, notification module 120 queries database 235 to determine whether the notification record allows the user to be notified about the content or software to be distributed. If, for example, the user has not yet been notified, notification module 120 may send the user an SMS message in step 420.

Upon receipt of the SMS message, users may be informed that they can download the content or software. To do so, they may, for example, follow a hyperlink included in the SMS message received. This link may either be accessed, for example, via a wireless application protocol (WAP) or hyper text transfer protocol (HTTP). When the user clicks on the link in the SMS message, device 105 may generate a WAP session protocol (WSP) or HTTP GET request. This request may start a provisioning script on repository web server 125 in order to identify the client device type so that the proper version of the software installer or content may be sent in response. Upon receipt of this installer, the device 105 browser may either launch the content or ask the user what action to take. If the provisioning script is unable to detect the client device type, a WAP or Web page may be sent to the user instead of the installer. This page may contain a list of supported device types, and the user may be prompted to select one, after which the proper installer or content version may be downloaded and installed. Alternatively the SMS message may itself embody the content to be delivered.

The present invention may be used in numerous applications, including, for example, in bandwidth optimization systems, particularly over wireless links. By lowering the bandwidth usage per user, a wireless network may support more traffic per user and/or more users. By the same token, better usage of the available bandwidth on a given link results in an enhanced user experience by lowering the transfer time for a given amount of data. In a first specific embodiment, there may be provided an apparatus residing on the network, which uses the data flow transported by the network to identify the capabilities of the application and protocols implemented on specific terminal devices and to apply selected data manipulation and reorganization techniques on the data flow to augment the efficiency of the use of the network resources, including the delivery of the data flow to the specific terminal devices. In a further specific embodiment, the apparatus residing on the network may further attempt to augment the efficiency of its performance and capabilities enhancements by using automated transparent and semi-transparent electronic provisioning techniques to deliver and install a software agent to specific terminal devices. The software agent may implement new capabilities on the specific terminal devices on which it is installed, thus enabling performance enhancements that may optionally rely on the presence of apparatus residing on the network. A bandwidth optimization system is depicted with respect to FIGS. 5-16 for illustrating an exemplary application of the present invention.

FIG. 5 is a block diagram of a bandwidth optimization system 500 according to an exemplary embodiment of the present invention. Bandwidth optimization system 500 may incorporate systems and methods similar to those described in FIGS. 1-4 into a communication path. Client or user devices 105 are coupled to network 110 through switch/hub 520. Network 110 is coupled to Internet 130 through a router/gateway 525. One or more Server Agent Nodes (SANs) 510-515 may be coupled to network 110.

Optimization Server Agent Node Clientless (OSAN-CL) 505 may provide improvement over data transmission in a manner that any user's protocol stack can understand the data without requiring a Client Agent Node (CAN) application. In order to augment the efficiency of the transmission, the OSAN-CL 505 may interpret a list of predefined standard protocol stacks, thereby discovering the user's protocol capabilities. Data flowing to the user may then be post-processed to utilize all capabilities of client 105.

Optimization Server Agent Node Client-based (OSAN-C) 510, similarly to OSAN-CL 505, may improve the data transmission efficiency between client 105 and the server (not shown). However, OSAN-C 510 may require the user to install a CAN application, which is able to interpret a list of predefined protocol stacks. Using an automatic, transparent, and protocol specific mechanism described in more detail below, the CAN application may detect the presence of the OSAN-C on the communication path, and vice-versa. A combination of OSAN-C 105 CAN-enabled device may make use of non-standard but more bandwidth efficient protocols.

Provisioning Server Agent node (PSAN) 515 may receive a notification from the OSAN-CL 505 for each new user connection with the server. This notification may include a client's 105 user ID information. Over a TCP/IP network, for example, the user ID information may be the user's IP address. PSAN 515 may also gather more specific information on the user, especially pertaining to the hardware or software being used by client 105. Using a transparent or semi-transparent approach, PSAN 515 may inform users and distribute the CAN application. When deployed, PSAN 515 server may enhance the network capacity by inviting users to install the CAN application.

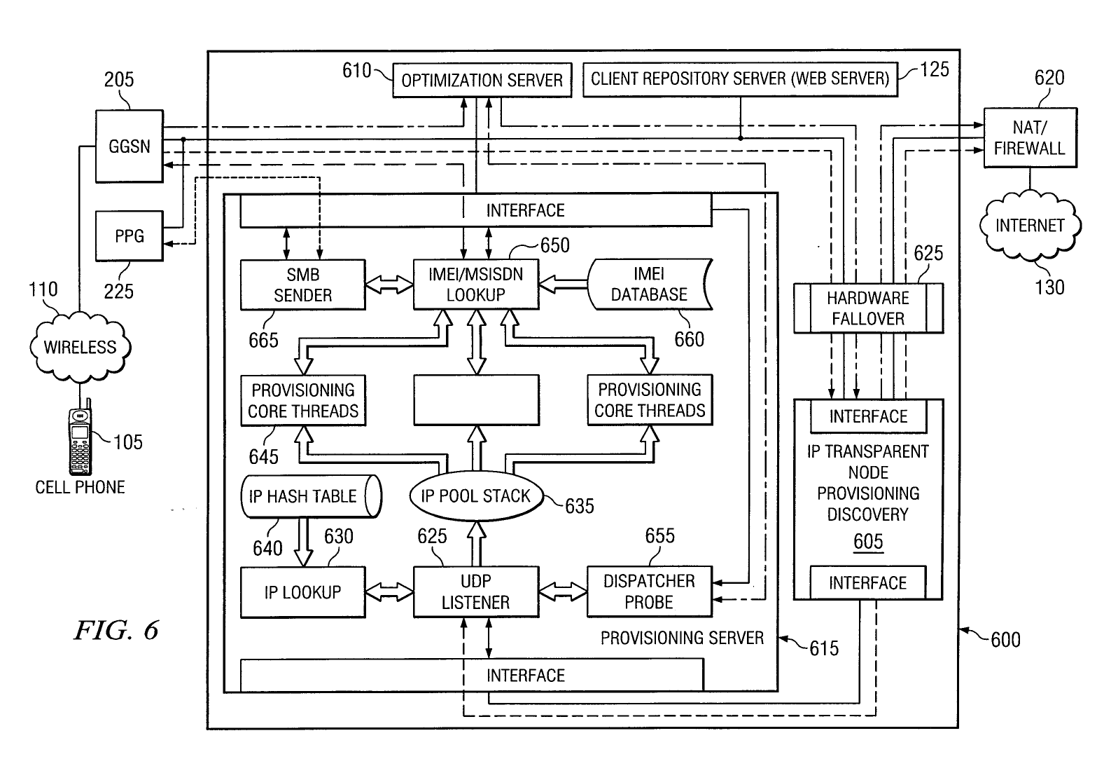

FIG. 6 is a block diagram of a bandwidth optimization system 600 according to an exemplary embodiment of the present invention. Client device 105 is coupled to bandwidth optimization system 600 through wireless network 110 and Gateway GPRS Support Node (GGSN) 205. Bandwidth optimization node 600 is coupled to Internet 130 through network address translation (NAT)/firewall 620. Bandwidth optimization system 600 may further comprise optimization server 610, client repository 125, hardware failover element 625, provisioning discovery server 605, and provisioning server 615. In one embodiment, since provisioning server 615 and optimization server 610 are both in the critical path of data flow, the functionality of both servers may be satisfied by the same hardware entity, such as a single server or a bank of servers. This embodiment has an economic advantage for network operators who already support a client-server optimization solution, or may be an incentive for those network operators who do not yet support such a solution to adopt it.

Provisioning discovery server 605 may be an IP-transparent node which resides on the network in the critical path of data flow. In some networks, a suitable server or node may already be located on the critical path and such server may be used as provisioning discovery server 605. Provisioning discovery server 605 may analyze packets sent by user device 105 on wireless network 110, and may also identify the capabilities of the applications and protocols implemented on device 105. For example, provisioning discovery server 605 may detect that device 105 is using a particular version of an Internet browser. When a particular application or protocol is detected, provisioning discovery server 605 may redirect the flow to optimization server 610.

Optimization server 610 may perform optimization techniques as a function of the applications and protocols detected by provisioning discovery server 605. For example, if a WAP protocol is detected, optimization server 610 may be able to concatenate packets destined for a WAP-enabled user device. On the other hand, if a web browser is detected, web pages may be compressed to different degrees, depending on the browser type. These are examples of core network optimization, which is characterized by there being no logic added to the user device, all optimization being conducted within optimization server 610.

Provisioning discovery server 605 may also detect when user device 105 has the potential to support a bandwidth optimization technique (whether it be stand-alone or client-server based). By way of example, the allgo*Mobile™ series of products from Cilys™ provides a variety of stand-alone and client-server optimization solutions, using data compression to optimize data transmission over a low bit rate link, such as, for example, GPRS and 1xRTT. The operation of bandwidth optimization node 600 is described in more detail below in the specific context of the allgo*Mobile™ solution. However, a person of ordinary skill in the art will recognize in light of this disclosure that the scope of the present invention is not limited to any particular bandwidth optimization technique. Furthermore, it will be understood by those of ordinary skill in the art that the present invention is not limited to the exemplary allgo*Mobile™ embodiment referenced herein. The term “provisioning,” as used herein, includes a way of deploying content to users over a network. The term “provisioning” also includes allowing a new installation of allgo*Mobile™ solution on an operator's network.

Provisioning discovery server 605 may analyze each packet sent by users on the wireless network and determine whether device 105 has allgo*Mobile™ installed. Provisioning discovery server 605 is preferably located in the critical path of the traffic flow of the operator's network. If provisioning discovery server 605 finds that device 105 is not currently optimized by allgo*Mobile™, a user datagram protocol (UDP) packet is sent to a transparent proxy server 615 (provisioning server), which is not connected in the critical path of data flow. For each packets received from the allgo*mobile servers, provisioning discovery server 605 may replace a source IP with a real client IP contained in the IP header option. Thus, each UDP packet or transmission control protocol (TCP) with TCP synchronization packet (SYN) flag up received from a user that has not been NATed by optimization server 610 may generate a UDP packet to the transparent proxy server 615. This UDP packet containing the source IP address may then be sent over a cross-linked interface to provisioning server 615. All manipulation of the IP address may be performed by provisioning server 615. For example, provisioning server 615 may read the information in the UDP packet (e.g., device IP address), and send a SMS notification message to device 105 with allgo*Mobile™ download information.

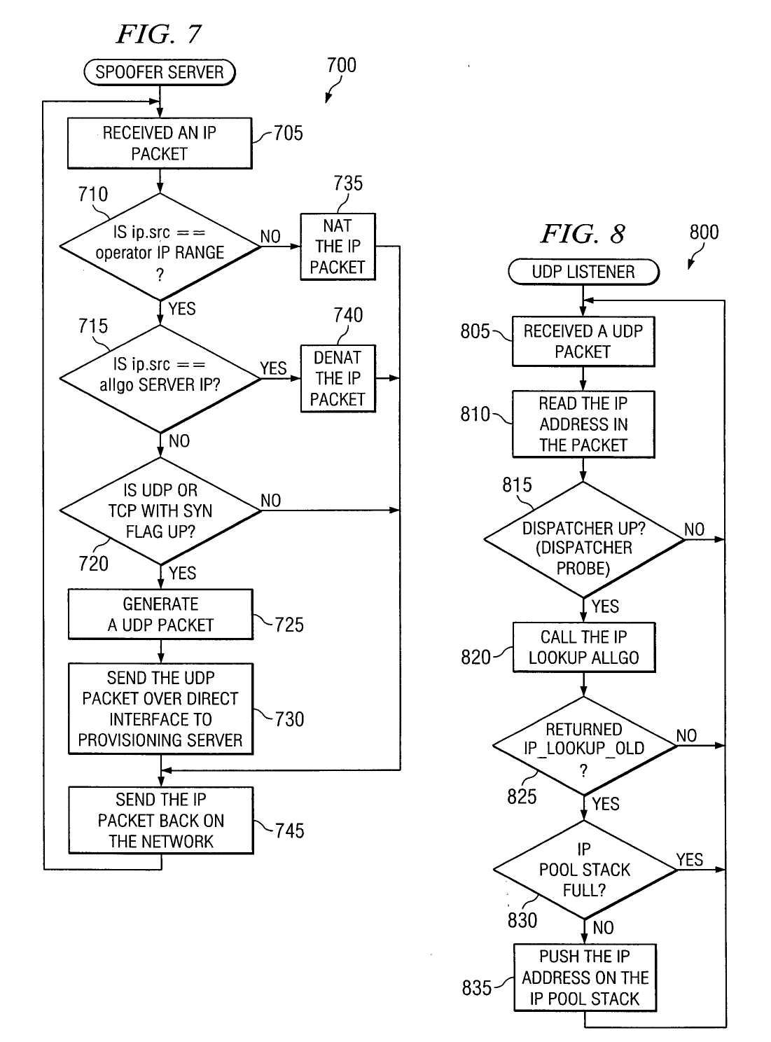

FIG. 7 is a flowchart of a method 700 performed by provisioning discovery server 605 depicted in FIG. 6, according to an exemplary embodiment of the present invention. Method 700 may be, for example, a threaded function created at startup. In step 705, an IP packet is received. In step 710, if ip.src is different from the operator IP range, the packet is NATed in step 735 and sent back to the network in step 745; otherwise control passes to step 715. In step 715, if ip.src is equal to the allgo server IP address, the packet is deNATed in step 740 and sent back to the network in step 745; otherwise control passes to step 720. In step 720, if the packet does not initiate a connection (neither TCP SYN nor WSP/UDP Connect), the packet is sent back to the network in step 745; otherwise a UDP packet is generated in step 725. This UDP packet contains the source IP address of the packet received in step 705. The UDP packet is sent to provisioning server 615 in step 730, and finally the packet is sent back to the network in step 745.

FIG. 8 is a flowchart of a method 800 performed by UDP listener module 625 depicted in FIG. 6, according to an exemplary embodiment of the present invention. Method 800 may be, for example, a threaded function created at startup. UDP listener module 625 may be responsible for reading and analyzing each UDP packet received from provisioning discovery server 605. Upon reception of a packet, an IP address may be read. UDP listener module 625 may use IP Lookup module 630 to verify whether the IP address has to be pushed into IP Pool Stack 635. In steps 805 and 810, a UDP packet is received and the IP address written in its payload is read. In step 815, a probe is performed to verify if the allgo*mobile dispatcher is up. If it is up, the IP lookup module 630 is called by step 820; otherwise control returns to step 805. Hence, step 815 bypasses the provisioning system when optimization server 610 is down. In step 825, if IP lookup module 630 does not return IP_LOOKUP_OLD, which means that this user has been notified recently, control returns to step 805; otherwise control passes to step 830. Therefore, step 825 filters IP address to analyze only new addresses. In step 830, if IP pool stack 635 is full control returns to step 805 thereby limiting the number of IP address in stack 635; otherwise the IP address is pushed into IP pool stack 635 in step 835, and control returns to step 805.

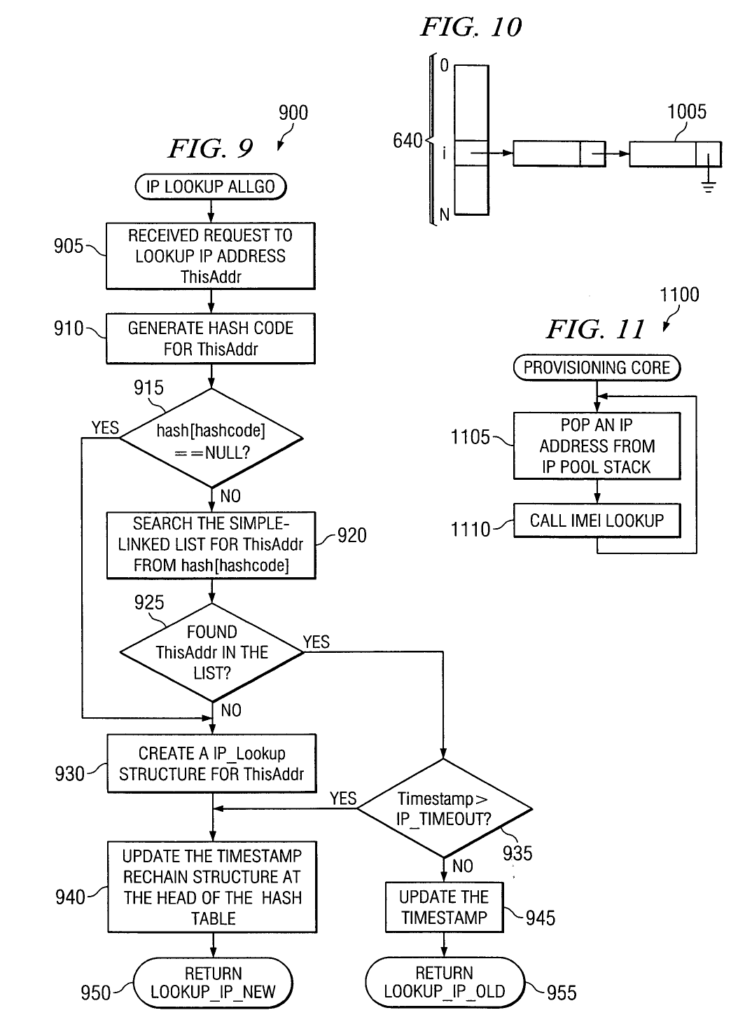

FIG. 9 is a flowchart of a method 900 performed by IP lookup module 630 depicted in FIG. 6, according to an exemplary embodiment of the present invention. Method 900 may be, for example, a threaded function created at startup. In one embodiment, IP lookup module 630 is a function built around hashing table 640, depicted in FIG. 6. IP lookup module 630 verifies whether the current IP address has already been signaled for a SMS notification message. Each IP address may be stored a structure 1005 of hashing table 640 and referenced by a hashcode. In one embodiment, because it is difficult to get dynamic host configuration protocol (DHCP) release information when the user disconnects from GPRS, structure 1005 may contain a timestamp to provide a time life for the IP address in hashing table 640. The timestamp may be refreshed at each packet received. When the timestamp is too old, method 900 may consider the IP address as a new client. In steps 905 and 910, IP lookup module 630 receives a request to lookup an IP address is and generates a hash code. The hash code may be generated, for example, using the last K bits of the IP address (e.g., for an IP address equal to 205.151.208.202, the hash code may be ((208)<<8|202). In step 915, if hash[hashcode] is equal to a null, an IP_Lookup structure is created in step 930, the timestamp is updated in step 940, and IP lookup module 630 returns LOOKUP_IP_NEW to UPD listener module 625 in step 950. In one embodiment, step 940 rechains the head of hashing table 640 in order to reduce the overall access time in sequential search through collisions. In step 915, if hash[hashcode] is not a null, IP lookup module 630 searches for the address in hashing table 640 and control passes to step 925. In step 925, if the address is not found, control passes to step 930; otherwise control passes to step 935. In step 935, IP lookup module 630 verifies whether the timestamp has timed-out. If so, control passes to step 940; otherwise the timestamp is updated in step 940 and IP lookup module 630 returns LOOKUP_IP_OLD to UDP listener module 325 in step 955.

FIG. 10 is a block diagram of hashing table 640 according to an exemplary embodiment of the present invention. In one embodiment, hashing table 640 contains pointers to IP_lookup structure 1005. IP_lookup structure 1005 may be, for example, a simple-linked list of collisions containing, for instance, an IP address, a timestamp, and a next pointer.

FIG. 11 is a flowchart of a method 1100 performed by provisioning core module 645 according to an exemplary embodiment of the invention. Method 1100 may be, for example, a group of threaded functions created at startup. In step 1105, provisioning core module 645 pops an IP address from IP pool stack 635 (depicted in FIG. 6), and checks if a SMS has to be sent to a client by calling international mobile equipment identification (IMEI) lookup module 650 in step 1110. A person of ordinary skill in the art will recognize in light of this disclosure that it is possible, by adding a UDP sender module (not shown), to send the IP address to a remote machine. The protocol may, for example, be the same as the one used between UDP Listener module 625 and provisioning discovery module 605. Thus, in case of very high traffic, the load may be distributed over multiple servers.

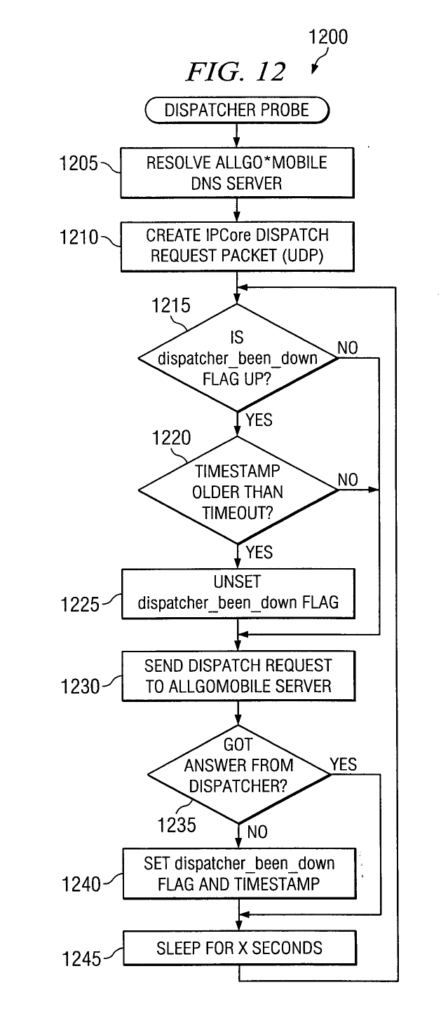

FIG. 12 is a flowchart of a method 1200 performed by dispatcher probe module 655 depicted in FIG. 6, according to an exemplary embodiment of the present invention. Method 1200 may be, for example, a threaded function created at startup. Dispatcher probe 655 may be used to verify the availability of the allgo*Mobile™ dispatcher. In one embodiment, dispatcher probe module 655 may hold SMS provisioning notification when the optimization server 610 is or has been down for a certain period of time. For example, a TIMEOUT timer may be around the average connected time for a user plus 1 or 2 standard deviations, so as to cover at least 90% of the user that have allgo*Mobile™ installed. In steps 1205 and 1210, dispatcher probe module 655 resolves a DNS server and creates an IPCore dispatch request UDP packet. In step 1215, dispatcher probe module 655 determines whether a dispatch_been_down flag is up. If not, dispatcher probe module 655 sends a dispatch request to optimization server 610 in step 1230 and control passes to step 1235; otherwise control passes to step 1220. In step 1220, if the time stamp of the packet is older than a TIMEOUT, then step 1225 unsets dispatch_been_down flag and control passes to step 1230; otherwise control passes to step 1230. In step 1235, if dispatcher probe module 655 receives an answer from optimization server 610 dispatcher, dispatcher probe module 655 sleeps for X seconds in step 1245; otherwise dispatcher_been_down flag and timestamp are set in step 1240 and control passes to step 1245. After sleeping for X seconds in step 1245, control returns to step 1215.

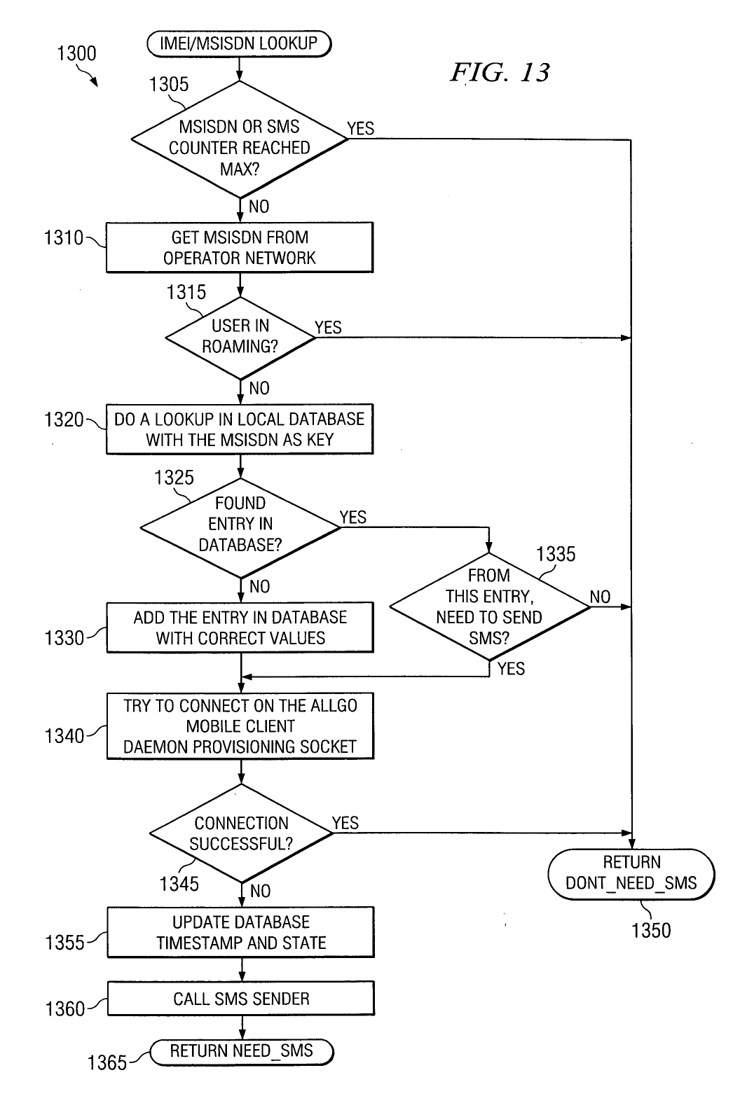

FIG. 13 is a flowchart of a method 1300 performed by IMEI/MSISDN lookup module 650 depicted in FIG. 6, according to an exemplary embodiment of the present invention. Method 1300 may be, for example, a threaded function created at startup. IMEI/MSISDN lookup module 650 may provide the user's phone number and device number to SMS sender 665 using IMEI database 660. In step 1305, IMEI/MSISDN lookup module 650 determines whether MSISDN or SMS counters have reached a maximum. If so, then IMEI/MSISDN lookup module 650 returns DON'T_NEED_SMS in step 1350 in order to control the deployment time curve of allgo*Mobile™ software client; otherwise IMEI/MSISDN lookup module 650 gets MSISDN from operator network in step 1310 and control passes to step 1315. In step 1315, if the user is roaming, IMEI/MSISDN lookup module 650 returns DON'T_NEED_SMS; otherwise IMEI/MSISDN lookup module 650 performs a lookup in IMEI database 660 using MSISDN as key and control passes to step 1320. In step 1325, IMEI/MSISDN lookup module 650 determines whether an entry was found in IMEI database 660. If so, then IMEI/MSISDN lookup module 650 uses at least one field of the IMEI database 660 in order to limit the number of SMS messages sent to a single user in step 1335 and control passes to step 1340; otherwise the entry is added to IMEI database 660 in step 1330. Steps 1340 and 1345 determine whether the client is already using allgo*Mobile™ software client by attempting to connect to a particular socket. If the connection is successful, then IMEI/MSISDN lookup module 650 returns DON'T_NEED_SMS in step 1350; otherwise IMEI/MSISDN lookup module 650 updates IMEI database 660 in step 1355, calls SMS sender module 665 in step 1360, and returns NEED_SMS in step 1365. In an alternative embodiment, steps 1340 and 1345 may be optional.

IMEI database 660 may be used to store the MSISDN and/or state values, and may contain, for example, the following fields for each entry:
MSISDN or IMEI (the key of the search)
Last sms (a timestamp of the last sms sent to the user)
Current state (an integer of the current state)
Nb_sms_sent (number of sms sent into the current-state)

In one embodiment, IMEI database 660 may use a MySQL system. In another embodiment, IMEI database 660 may be a relational database method (RDBM) or an indexed sequential access database method (ISAM). Preferably, IMEI database 660 may be accessed via key search.

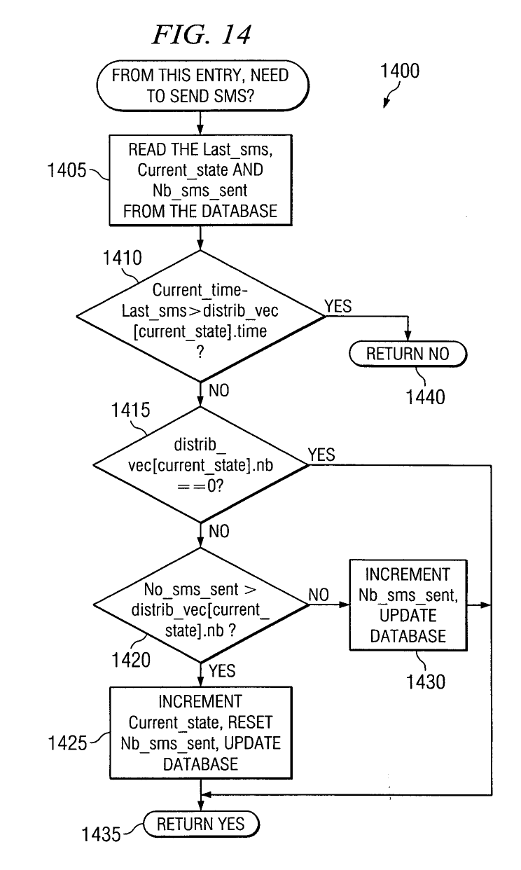

FIG. 14 is a flowchart of a method 1400 performed by SMS sender module 665 depicted in FIG. 6, according to an exemplary embodiment of the present invention. Method 1400 may be, for example, a threaded function created at startup. SMS sender module 665 may be responsible for creating and managing an SMS transmission to the user. In an embodiment, this SMS contains at least the URL of the allgo*Mobile™ client installer, or any web page with a link to the installer. In another embodiment, a field for each entry in the IMEI database 660 may be used to control the frequency of SMS messages sent to a particular user. In order to avoid flooding each user with SMS messages, a distribution vector and state may be used, such as, for example:

```
unsigned char state
struct distrib_vec_t{
  unsigned int time; /* time(in days) between 2 sms transmissions*/
  unsigned int nb;  /* max nb sms to send for a state*/
} distrib_vec[4]={{1,2},{2.2},{7,1},{14,0}};
```

In this example, each pair {x,y} in the vector is indexed by a state, i.e., distrib_vec[i] gives the pair {x,y} for the state i. In state zero, one SMS message may be sent. In state one, an SMS message may be sent everyday for two days. In state two, an SMS message can be sent every 7 days, but only once. Finally, at state 3, a SMS can be sent every 2 weeks, without further limitation.

In step 1405, SMS sender module 665 reads at least one SMS parameter from IMEI database 660. In step 1410, if the user has already received the maximum number of SMS messages allowed control passes to step 1440 and SMS sender module 665 does not send an SMS message. In step 1415, if the number of SMS sent in a given state of the distribution vector is zero, SMS sender module 665 sends an SMS message to the user in step 1435 by notifying PPG 225. In step 1420, if the number of SMS sent is larger than the number of SMS to send within a given state, the control passes to step 1425, where the state is changed and the counter of the number of SMS sent reset. Else, the control passes to step 1430, where the counter of the number of SMS sent is incremented.

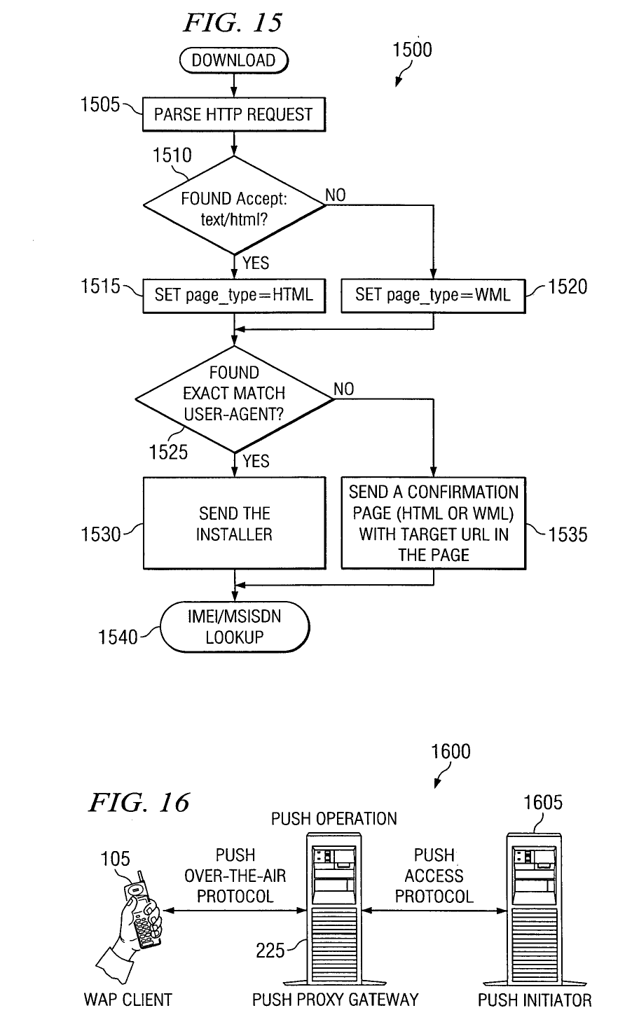

FIG. 15 is a flowchart of a method 1500 performed by client repository server 125 depicted in FIG. 6, according to an exemplary embodiment of the present invention. Method 1500 may be, for example, a threaded function created at startup. Client repository server 125 may be, for example, an Apache server used for the distribution of the allgo*Mobile™ clients. In one embodiment, client repository server 125 may be able to parse the HTTP header to find the user and select the best appropriate installer for device 105. Method 1500 may be implemented in any program language, such as, for example, java or perl. In step 1505, client repository server 125 parses an HTTP request. Steps 1515 and 1520 set the page type as HTML or wireless markup language (WML) depending upon the result of parsing in step 1510. Step 1530 sends the installer to device 105 if an exact user-agent match is found; otherwise step 1535 sends a confirmation page to device 105 with the target URL in the appropriate format. Finally, step 1540 performs an IMEI/MSISDN lookup in order to determine a device's 105 phone number.

FIG. 16 is a block diagram of push proxy gateway/server 225 depicted in FIG. 6 according to an exemplary embodiment of the present invention. Push initiator 1605 sends an HTTP post request formatted according to Push Access Protocol (PAP) to PPG 225. PPG 225 interprets PAP and formats suited for client 105 and sends it to client 105. Addressing information is incorporated in the PAP. In one embodiment, push initiator server 1605 is included in SMS sender module 665 inside provisioning server 615.

It will thus be appreciated from the description of the bandwidth optimization system depicted in FIGS. 5-16 above, that this exemplary embodiment of the present invention involves only a limited increase of hardware components (if any), does not interfere or reduce optimization performance, detects whether a user does or does not have allgo*Mobile™ installed, and permits a smooth deployment of allgo*Mobile™ without traffic peaks.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A bandwidth optimization system comprising:
a detector module configured to:
intercept a communication sent from a client device of a first network to a second network;
determine a network address identifier from the intercepted communication; and
identify the capabilities of one or more applications and/or protocols implemented on the client device based on the determined network address identifier, the system further comprising:
an optimization module configured to optimize, based on the capabilities identified by the detector module, usage of available bandwidth in sending data from the second network to the client device.

2. The system of claim 1, wherein the optimization module is configured to manipulate and/or reorganize the data in order to optimize usage of the available bandwidth.

3. The system of claim 1, wherein the optimization module is configured to optimize usage of the available bandwidth by optimizing network resource usage.

4. The system of claim 1, wherein the optimization module is configured to compress web pages based on an identified browser type used by the client device.

5. The system of claim 1, wherein the detector module is configured to:
use the determined network address identifier to determine whether bandwidth optimization software is installed on the client device.

6. The system of claim 5, further comprising a notification module, coupled to the detector module, wherein, in the event that the bandwidth optimization software is not installed on the client device, the notification module is configured to use the determined network address identifier to send the client device a notification message comprising data relating to the installation of the bandwidth optimization software.

7. The system of claim 6, wherein the bandwidth optimization system further comprises a database comprising notification information, the notification information comprising data indicative of notifications sent to client devices regarding the bandwidth optimization software; and
wherein the notification module is configured to:
query the database in respect of the client device in order to determine notification information in respect of the bandwidth optimization software for the client device; and
send the client device a notification message comprising data relating to the installation of the bandwidth optimization software if the detector module determines that the client device has not been notified in respect of the bandwidth optimization software.

8. The system of claim 6, wherein the notification message comprises an SMS message containing bandwidth optimization software download information.

9. A method of optimizing bandwidth comprising:
intercepting a communication sent from a client device of a first network to a second network;
determining a network address identifier from the intercepted communication;
identifying the capabilities of one or more applications and/or protocols implemented on the client device based on the determined network address identifier; and
optimizing, based on the capabilities identified by the detector module, usage of available bandwidth in sending data from the second network to the client device.

10. The method of claim 9, wherein optimizing usage of the available bandwidth comprises manipulating and/or reorganizing the data.

11. The method of claim 9, wherein optimizing usage of the available bandwidth comprises optimizing network resource usage.

12. The method of claim 9, wherein optimizing usage of the available bandwidth comprises compressing web pages based on an identified browser type used by the client device.

13. The method of claim 9, further comprising using the determined network address identifier to determine whether bandwidth optimization software is installed on the client device.

14. The method of claim 13, further comprising, in the event that the bandwidth optimization software is not installed on the client device, using the determined network address identifier to send the client device a notification message comprising data relating to the installation of the bandwidth optimization software.

15. The method of claim 14, further comprising:
querying a database that comprises notification information, in respect of the client device, the notification information comprising data indicative of notifications sent to client devices regarding the bandwidth optimization software, in order to determine notification information in respect of the bandwidth optimization software for the client device; and
sending the client device a notification message comprising data relating to the installation of the bandwidth optimization software if it is determined that the client device has not been notified in respect of the bandwidth optimization software.

16. The method of claim 14, wherein the notification message comprises an SMS message containing bandwidth optimization software download information.
